(19) United States
(12) Patent Application Publication
(10) Pub. No.: US 2016/0333224 A1
(43) Pub. Date: Nov. 17, 2016

(54) METHOD FOR MANUFACTURING SILICON-COLORED COMPOSITE PATCH

(71) Applicant: SUNNY PROCESS CORPORATION, New Taipei City (TW)

(72) Inventor: Kuan Ju LAI, New Taipei City (TW)

(73) Assignee: SUNNY PROCESS CORPORATION, New Taipei City (TW)

(21) Appl. No.: 14/709,163

(22) Filed: May 11, 2015

(51) Int. Cl. C09J 7/02; C09J 7/04; B05D 7/02; B05D 3/00; B05D 7/00; B05D 7/14

(52) U.S. Cl. CPC C09J 7/0203; B05D 7/584; B05D 7/14; B05D 7/02; B05D 3/007; C09J 7/0292; C09J 7/043; C09J 7/0282; C09J 7/0242; C09J 2483/00; C09J 2483/006

(57) ABSTRACT

The method of manufacturing the silicon-colored composite of the present invention includes the steps of: providing a substrate layer that is made up of a heat-resistant material; coating a surface of the substrate layer with a first interfacial agent; drying the first interfacial agent so as to enable a first interfacial layer to be formed; formation of the first pattern layer on the surface of the first interfacial layer; the coating of a second interfacial agent on the surface of the first pattern layer, so as to enable the second interfacial layer to be formed by means of drying the second interfacial agent; the placing of the adhesive material on the surface of the second interfacial layer, and a high pressure treatment and a high temperature treatment were carried out on the adhesive materials in order to enable the adhesive layer to be formed. In addition, the adhesive materials include a silicone gel, a hardening agent, a colored plastic as well as an adhesive agent. The present invention's adhesive layer, pattern layer and the substrate layer are mutually combined and fixed by means of the interfacial agent. In addition, the aesthetic effect of the silicon-colored composite patch of the present invention is enhanced by means of the pattern layer. Besides the above, a strong adsorption effect can be produced when the silicon-colored composite patch of the invention is in contact with a flat surface, subsequent to high temperature and high pressure treatments of the adhesive layer.

### FIELD OF THE INVENTION

The present invention relates generally to a method of manufacturing a patch that can directly produce an adsorption effect subsequent to direct contact with an object, and more particularly, the present invention relates to a manufacturing method for a silicon-colored composite patch that has an enhanced aesthetic effect, and that is able to produce an adsorption effect upon contact.

### BACKGROUND OF THE INVENTION

A patch is a type of man-made product that has adhesiveness. Following the evolution of technology, a patch not only can act as a link between two different objects, by being adhered to the surfaces of some products; or a patch may have a protective function, by acting as some form of shield. Also, a patch may be used more widely in various fields such as the food industry, clothing industry, hotel industry as well as the recreation industry.

At present, the production lines of the electronics industry make use of a heat-resistant tape for adhering and fixing a workpiece as well as for carrying out the process of production. Subsequent to the completion of production, the heat-resistant tapes need to be removed from the workpiece, and furthermore, following the process treatment, the heat-resistant tape may not be used a second time. As such, the subsequent operations which are involved with the processing of the heat-resistant tape is associated high costs of human resources, and relatively speaking, the costs of manufacture are also increased. In addition to the above, the manufacturing process may also be associated with changes in the quality and the structure of the heat-resistant tape, and in such times, toxic substances may be produced. And if these toxic substances are inhaled into the human body, a level of harm will certainly be brought to the human body.

During normal application by the general population, a tape will gradually lose its adhesive effect after being used for a certain period of time, as a result of time and environmental factors. As such, during normal use, the user needs to pay regular attention to the adhesiveness of the tape, and whether the tape still has standard adhesiveness; and the tape needs to be replaced before its adhesiveness is lost completely. Moreover, use of this type of tape is associated with great inconvenience, since the tape may not be reused once the adhesive effect of the tape is lost, or when there is insufficient adhesiveness of the tape.

### SUMMARY OF THE INVENTION

The main objective of the present invention is that when the silicon-colored composite patch of the present invention is adhered to a flat surface, an adsorption effect will be automatically generated. Such an adsorption effect will not be affected by time and environmental factors, causing the adsorption effect to be lost. On the contrary, the silicon-colored composite patch of the present invention enables the adsorption intensity to be increased the longer the composite patch is adhered to the flat surface, and as such, the composite patch is not easily detached from the flat surface.

The other objective of the present invention is that a colored pattern is formed on the silicon-colored composite patch of the present invention, and this greatly enhances the aesthetic effect of the card. In addition, the convenience of the silicon-colored composite patch may be significantly increased. In addition, the composite patch may be detached from a flat surface. Moreover, the composite patch may be reinstalled and attached on the silicon-colored composite patch.

In order to achieve the above-mentioned objectives of the present invention, the method for manufacturing the silicon-colored composite patch includes the following steps: a substrate layer that is made up of a heat-resistant material may be provided, whereby the substrate layer may include a first surface and a second surface; a first interfacial agent may be coated on the first surface of the substrate layer, so as to enable a first interfacial layer to be formed by means of drying the first interfacial agent; a first pattern layer may be formed on the surface of the first interfacial layer; a second interfacial agent may be coated on the surface of the first pattern layer, so as to enable a second interfacial layer to be formed by means of drying the second interfacial agent. Moreover, other steps of the method of manufacturing the silicon-colored composite patch of the invention involves placing an adhesive material on the surface of the second interfacial layer, so as to enable an adhesive layer to be formed by means of subjecting the adhesive material to a high temperature and a high pressure treatment, whereby the adhesive material may include a silicone gel, a hardening agent, a colored plastic and an adhesive agent.

In accordance with the first preferred exemplary embodiment of the present invention, the manufacturing method of the present invention may further include the step of placing a second pattern layer on the second surface of the substrate layer subsequent to the completion of the adhesive layer.

In accordance with another preferred exemplary embodiment of the present invention, the method of manufacturing the silicon-colored composite patch of the present invention may further include the step of placing a second pattern layer on the second surface of the substrate layer subsequent to the completion of the adhesive layer; a third interfacial agent may be coated on the surface of the second pattern layer; and the third interfacial layer may be formed by means of drying the third interfacial agent; and a surface layer may be formed on the surface of the third interfacial layer.

In accordance with yet another preferred exemplary embodiment of the present invention, the method of manufacturing the silicon-colored composite patch of the present invention may further include the step of coating a third interfacial agent on the surface of the second pattern layer, so as to enable the third interfacial layer to be formed by means of drying the third interfacial agent. Furthermore, the surface layer may also be formed on the surface of the third interfacial layer subsequent to the completion of the adhesive layer.

Out of the three different methods of manufacturing the silicon-colored composite patch mentioned above, in accordance with the three preferred exemplary embodiments of the present invention, prior to the step of the coating of the first interfacial agent, and surface roughening treatment may be carried out on at least a surface of the substrate layer in order for the rough surface to be formed. In addition, the first pattern layer may be formed on the first interfacial layer by means of one of the method of spraying or screen printing.

Besides the above, the heat-resistant material may be selected from the following group of: a PET plate, an aluminum plate, and a galvanized iron plate. In addition, the heat-resistant materials may also include two materials such as a fiberglass cloth and an epoxy resin, or the heat-resistant materials may be made up by the combination of a fiberglass cloth, an epoxy resin and graphite.

Moreover, the surface layer of the present invention may be selected from the following group of: a double-sided tape, a fiberglass plastic and a non-slip material, of which this is dependent on need and purpose during use.

The silicon-color composite patch of the present invention may be formed by means of the manufacturing method mentioned above. The silicon-color composite patch may include a substrate layer that is made up of a heat-resistant material, a first interfacial layer that is located on the surface of the substrate layer, a first pattern layer that is located on the surface of the first interfacial layer, a second interfacial layer that is located on the surface of the above-mentioned pattern layer, as well as an adhesive layer that is located on the surface of the second interfacial layer.

The distinguishing technical feature of the present invention lies in the fact that the adhesive layer, the first pattern layer as well as the substrate layer may be firmly combined by means of the first interfacial layer and the second interfacial layer. Moreover, a strong adsorption effect will be automatically generated subsequent to high temperature and high pressure treatments of the adhesive layer. Furthermore, the adsorption effect will not be lost or reduced as a result of time or environmental factors. On the contrary, the longer the silicon-colored composite patch of the present invention is adhered to the surface, the more firmly it will adhere to the flat surface, and will not be detached from the surface easily. In addition to the above, a colored pattern may be formed on the silicon-colored composite patch of the present invention, and this significantly enhances the aesthetic effects of the silicon-colored composite patch. Also, the convenience of the composite patch may be significantly increased. In addition, the composite patch may be detached from a flat surface. Moreover, the composite patch may be reinstalled and attached on the silicon-colored composite patch.

### BRIEF DESCRIPTION OF THE DRAWINGS

The present invention can be understood in more detail by reading the subsequent detailed description in conjunction with the examples and preferred exemplary embodiments made to the accompanying drawings, wherein:

FIG. 1 is a flow chart showing the first method of manufacturing the silicon-color composite patch of the present invention.

FIG. 2A to FIG. 2B are the structural schematic diagrams showing the processes of FIG. 1.

FIG. 3 is a schematic diagram showing the roughening of the surface of the substrate layer of the silicon-colored composite patch of the present invention.

FIG. 4 is a flow chart showing another method of manufacturing the silicon-colored composite patch in accordance with the second preferred exemplary embodiment of the present invention.

FIG. 5 is a structural schematic diagram showing the processes of FIG. 4.

FIG. 6 is a flow chart showing another method of manufacturing the silicon-colored composite patch in accordance with the third preferred exemplary embodiment of the present invention.

FIG. 7A to FIG. 7B are the structural schematic diagrams showing the processes of FIG. 6.

### DETAILED DESCRIPTION OF THE PREFERRED EMBODIMENT

The accompanying drawings are included to provide a further understanding of the invention, and are incorporated in and constitute a part of this specification. The drawings illustrate the preferred exemplary embodiments of the invention and, together with the description, serve to explain the principles of the invention.

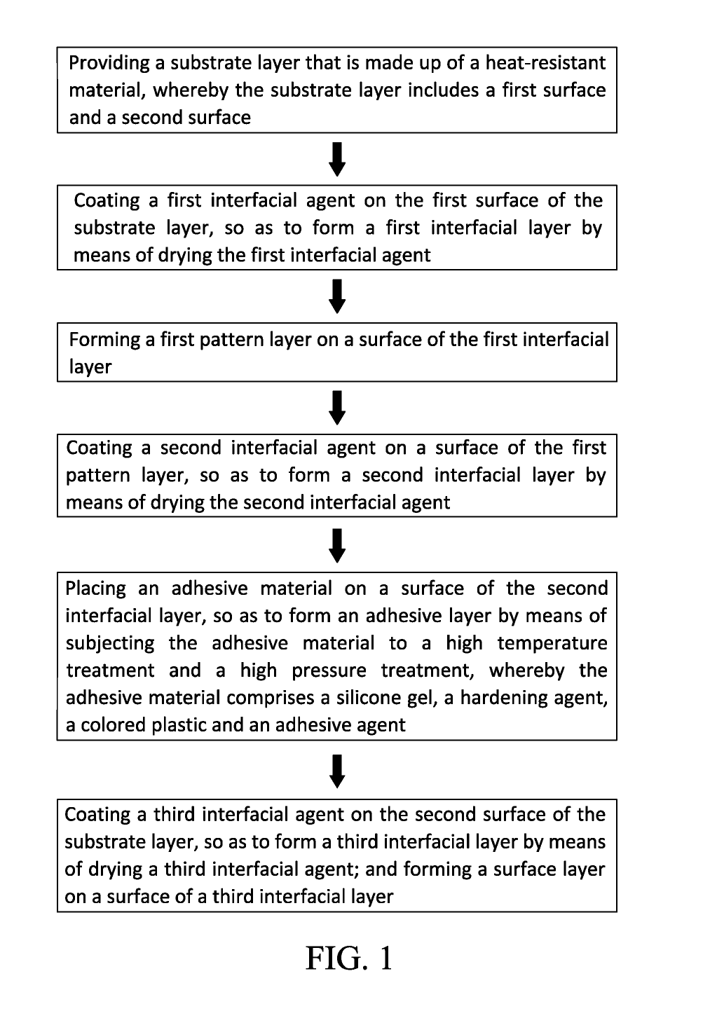

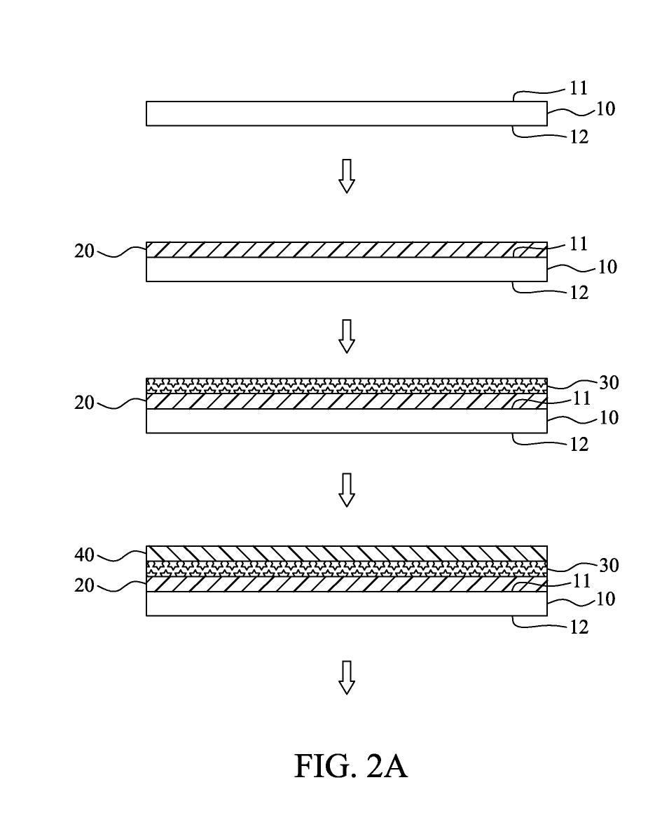

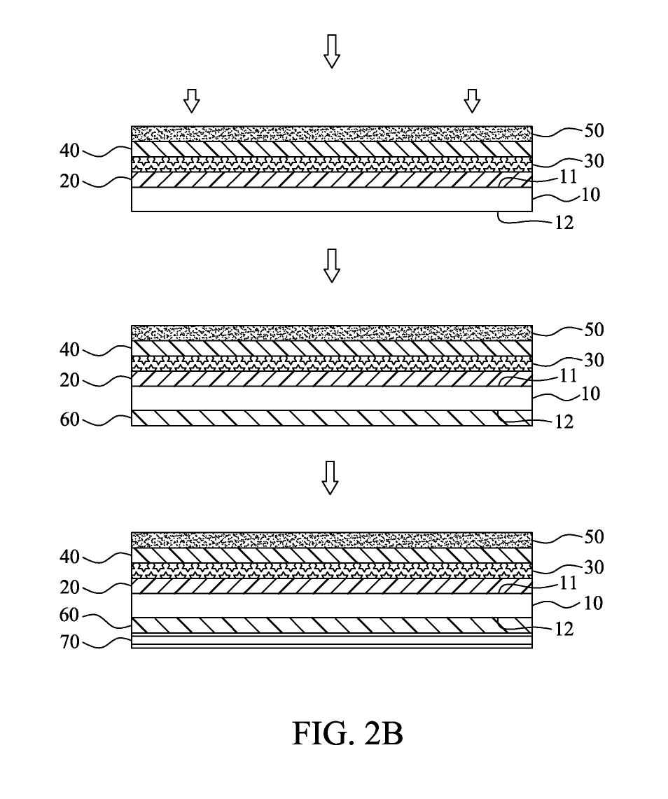

As shown in FIG. 1, FIG. 2A to FIG. 2B as well as the first preferred exemplary embodiment of the present invention, the method of manufacturing the silicon-color composite patch of the invention involves the following steps:

(1) A substrate layer 10 that is made up of a heat-resistant material may be provided; the substrate 10 layer may include a first surface 11 and a second surface 12. The heat-resistant materials of the substrate layer 10 may be selected from one of the following: a PET plate, an aluminum plate and a galvanized iron plate.
(2) The first surface 11 of the substrate layer 10 may be coated with the first interfacial agent, and the first interfacial layer 20 may be formed by means of drying the first interfacial agent. The drying of the first interfacial agent may be carried out at the temperature of 80° C.
(3) The first pattern layer 30 may be formed on the surface of the first interfacial layer 20. The first pattern layer 30 may be formed mainly by means of the spraying method.
(4) The surface of the first pattern layer 30 may be coated with a second interfacial agent, so as to enable the second interfacial layer 40 to be formed by means of drying the second interfacial agent. Similarly, the drying of the second interfacial agent may be carried out at the temperature of 80° C.
(5) An adhesive material may be placed on the surface of the second interfacial layer 40, so as to enable an adhesive layer 50 to be formed by means of subjecting the above-mentioned adhesive materials to a high temperature treatment and a high pressure treatment. The adhesive materials may include a silicone gel, a hardening agent, a colored plastic as well as an adhesive agent. The condition required for carrying out the high pressure treatment may include a pressure of 20 tons, and the high temperature required may be a temperature of 200° C. The adhesive layer 50 may be formed after 20 minutes of processing at the above-mentioned conditions.
(6) The third interfacial agent may be coated on the second surface 12 of the substrate layer 10, so as to enable the third interfacial layer 60 to be formed by means of drying the third interfacial agent. The drying of the third interfacial agent may be carried out at the temperature of 80° C.
(7) The surface layer 70 may be formed on the surface of a third interfacial layer 60, and the surface layer 70 may be configured as a one of the following: a double-sided tape, a fiberglass plastic or a non-slip material.

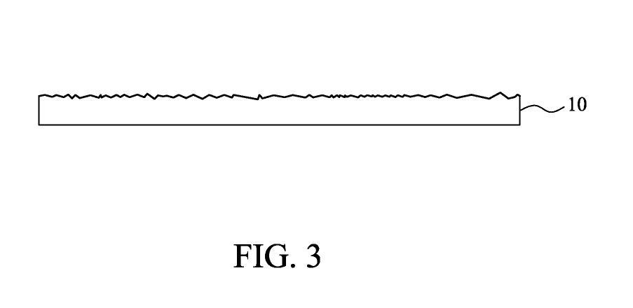

As shown in FIG. 3, surface roughening treatment of at least a surface of the substrate layer 10 of the present invention may be carried out prior to the step of the coating of the first interfacial agent on the substrate layer 10, so as to enable the rough surface 13 to be formed. This has the effect of increasing the combination strength between the interfacial layer and the substrate layer 10, when the interfacial layer is formed from the first interfacial agent and/or the third interfacial agent.

In addition, irregularities of the parts and materials may be produced subsequent to the high temperature treatment and high pressure treatment of the surface of the adhesive layer 50 (not shown in the drawings). As such, subsequent to the step of the formation of the adhesive layer 50 as a result of the high pressure and high temperature treatments, the step of further treating the surface may be carried out, so as to enable the surface of the adhesive layer 50 to be smooth and horizontal.

Moreover, the materials and ingredients for the above-mentioned adhesive layer 50 have been stated for illustrative purposes only, and are not meant to be limiting. Besides the use of the four materials such as a silicone gel, a hardening agent, a colored plastic as well as an adhesive agent for the manufacture of the adhesive layer 50, the adhesive layer 50 may also be made from other additional materials.

As shown in FIG. 2, the silicon-colored composite patch that has been manufactured by means of the above-mentioned manufacturing method may also include the following: the substrate layer 10 that is made up of a heat-resistant material, a first interfacial layer 20 that is located on the surface of the substrate layer 10, a first pattern layer 30 that is located on the surface of the first interfacial layer 20, a second interfacial layer 40 that is located on the surface of the first pattern layer 30, an adhesive layer 50 that is located on the surfaced of the second interfacial layer 40, a third interfacial layer 60 that is located on another surface of the substrate layer 10, as well as a surface layer 70 that is located on the surface of the third interfacial layer 60.

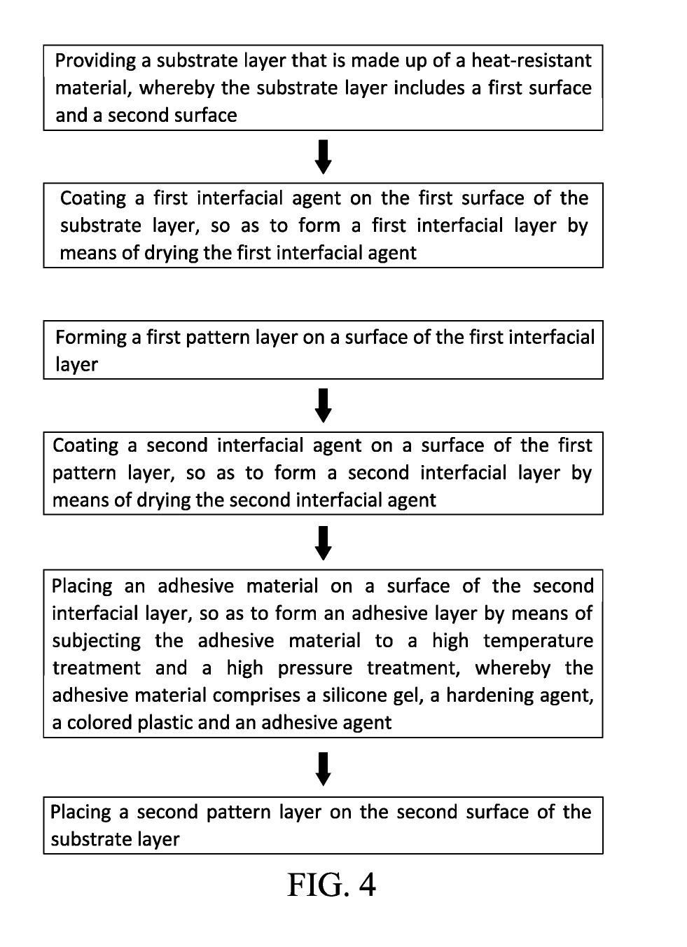

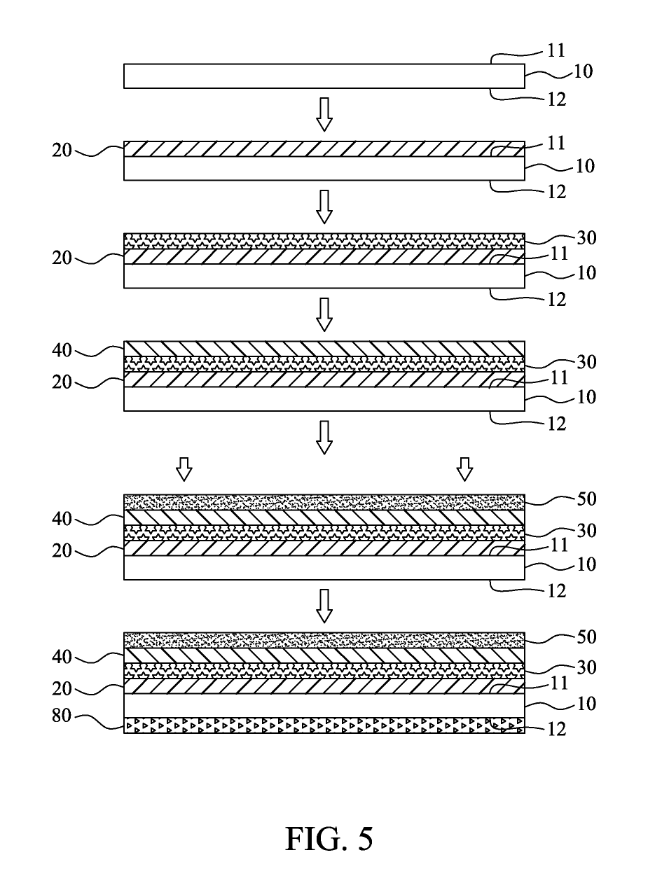

Moreover, as shown in FIG. 4 and FIG. 5, in accordance with the second preferred exemplary embodiment of the present invention, the silicon-color composite patch of the present invention may also be manufactured by means of the steps as follows:

(1) The substrate layer 10 that is made up of a heat-resistant material may be provided. The substrate layer 10 may include a first surface 11 and a second surface 12. The heat-resistant materials of the substrate layer 10 may be combined by means of two materials such as a fiberglass cloth and an epoxy resin.
(2) The first surface 11 of the substrate layer 10 may be coated with the first interfacial agent, so as to enable the first interfacial layer 20 to be formed by means of drying the first interfacial agent. The drying of the first interfacial may be done by means of natural drying method.
(3) The first pattern layer 30 may be formed on the surface of the first interfacial layer 20, and the first pattern layer 30 may be formed by means of the method of screen printing.
(4) The surface of the first pattern layer 30 may be coated with a second interfacial agent, so as to enable the second interfacial layer 40 to be formed by means of drying the second interfacial agent. The drying of the first interfacial agent may be achieved by means of the natural drying method.
(5) The adhesive materials may be placed on the surface of the second interfacial layer 40, and an adhesive layer 50 may be formed by means of a high temperature treatment and a high pressure treatment of the adhesive materials. The adhesive materials may include a silicone gel, a hardening agent, a colored plastic as well as an adhesive agent. The condition required for carrying out the high pressure treatment may include a pressure of 20 tons, and the high temperature condition required may be a temperature of 220° C. The adhesive layer 50 may be formed subsequent to 15 minutes of processing at the above-mentioned conditions.
(6) The second pattern layer 80 may be placed on the second surface 12 of the substrate layer 10. The second pattern layer 80 may be formed by means of the method of screen printing.

In accordance with the second preferred exemplary embodiment of the present invention, surface roughening treatment and surface treatment may also be carried out on the substrate layer 10, so as to increase the combined strength in between the interfacial layer as well as the substrate layer 10. This may also enable the surface of the adhesive layer 50 to be smooth, in order to strengthen the adsorption effect.

Moreover, as shown in FIG. 5, in accordance with the second preferred exemplary embodiment of the present invention, the silicon-color composite patch may include: a substrate layer 10 that is made up of a heat-resistant material, a first interfacial layer 20 that is located on the surface of the substrate layer 10, a first pattern layer 30 that is located on the surface of the first interfacial layer 20, a second interfacial layer 40 that is located on the surface of the first pattern layer 30, an adhesive layer 50 that is located on the surface of the second interfacial layer 40 as well as a second pattern layer 80 that is located on another surface of the substrate layer 10.

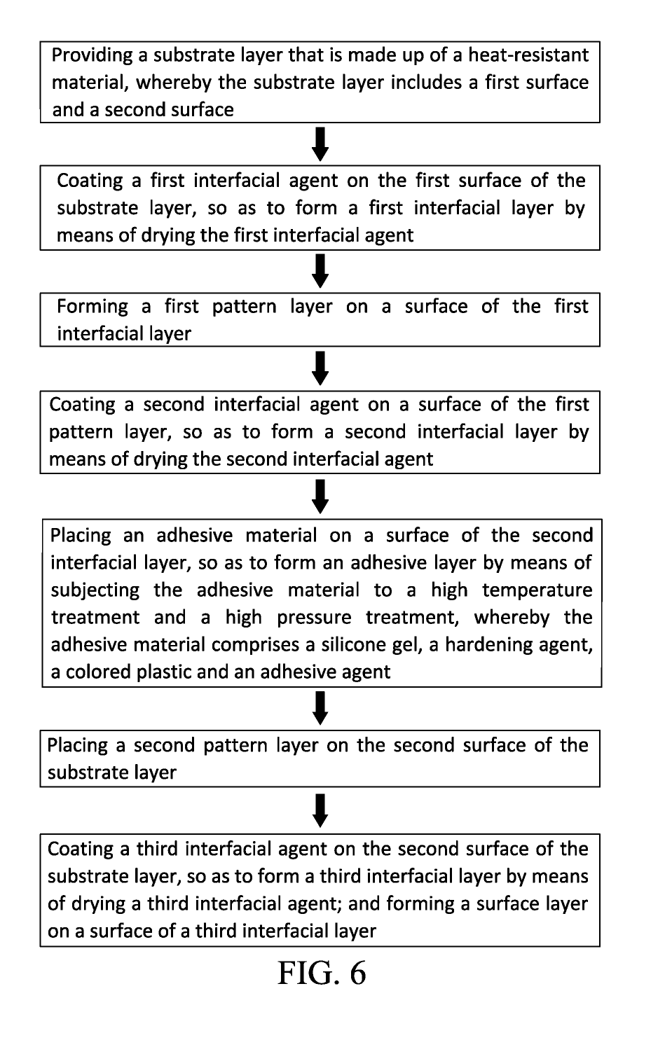

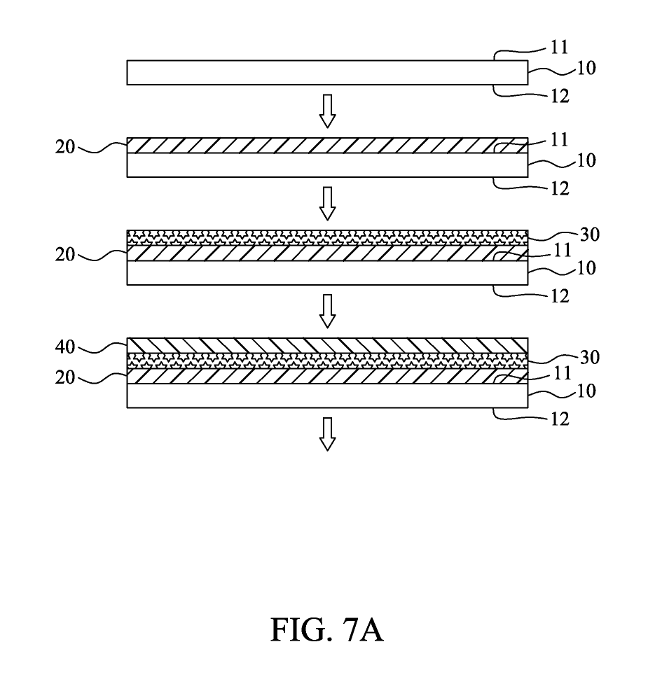

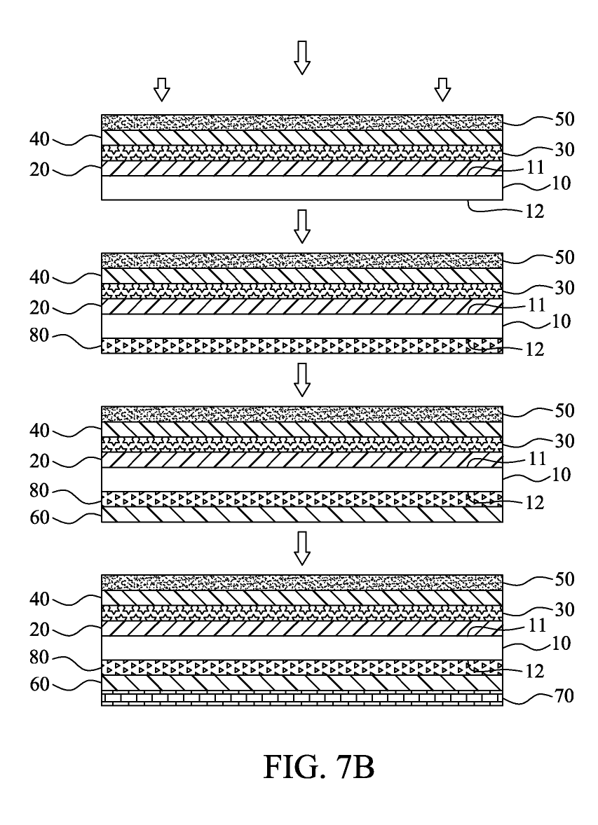

In addition, as shown in FIG. 6, FIG. 7A to FIG. 7B and in accordance with the third preferred exemplary embodiment of the present invention, the steps of manufacturing the silicon-color patch of the present invention include the following steps:

(1) The substrate layer 10 that is made up of a heat-resistant material may be provided. The substrate layer 10 may include a first surface 11 and a second surface 12. The heat-resistant materials of the substrate layer 10 may be formed from the combination of the following: a fiberglass cloth, an epoxy resin and a graphite.
(2) The first surface 11 of the substrate layer 10 may be coated with the first interfacial agent, and the first interfacial layer 20 may be formed by means of drying the first interfacial agent. The drying of the first interfacial agent may be carried out by one of the following methods: drying at the temperature of 80° C., or the first interfacial agent may be dried naturally.
(3) The first pattern layer 30 may be formed on the surface of the first interfacial layer 20. The first pattern layer 30 may be formed by one of the following methods: the screen printing or the spraying picture method.
(4) The surface of the first pattern layer 30 may be coated with a second interfacial agent, to enable the second interfacial layer 40 to be formed by means of drying the second interfacial agent. The drying of the second interfacial agent may be carried out by one of the following methods: drying at the temperature of 80° C., or the second interfacial agent may be dried naturally.
(5) An adhesive material may be placed on the surface of the second interfacial layer 40, so as to enable an adhesive layer 50 to be formed by means of subjecting the above-mentioned adhesive materials to a high temperature treatment and a high pressure treatment. The adhesive materials may include a silicone gel, a hardening agent, a colored plastic as well as an adhesive agent. The high temperature and high pressure treatments may include a pressure of 20 tons, and a temperature of 180° C. The adhesive layer 50 may be formed subsequent to 25 minutes of processing at the above-mentioned conditions.
(6) The second pattern layer 80 may be placed on the second surface 12 of the substrate layer 10. The second pattern layer 80 may be formed by means of one of the following methods: the screen printing method or the spraying picture method.
(7) The third interfacial agent may be coated on the surface of the second pattern layer 80, so as to enable a third interfacial layer 60 to be formed by means of drying the third interfacial agent. The drying of the third interfacial agent may be carried out by one of the following conditions: drying at the temperature of 80° C., or the third interfacial agent may be dried naturally.
(8) A surface layer 70 may be formed on the surface of the third interfacial layer 60. The surface layer 70 may be configured as one of the following: a double-sided tape, a fiberglass plastic or non-slip material.

In accordance with the third preferred exemplary embodiment of the present invention, procedures such as surface roughening treatment and surface treatment of the substrate layer 10 may also be carried out in accordance with need, and is thus not described further here.

As shown in FIG. 7B, the silicon-color composite patch in accordance with the third preferred exemplary embodiment of the present invention includes: a substrate layer 10 that is made up of a heat-resistant material, a first interfacial layer 20 that is located on the surface of the substrate layer 10, a first pattern layer 30 that is located on the surface of the first interfacial layer 20, a second interfacial layer 40 that is located on the surface of the first pattern layer 30, an adhesive layer 50 that is located on the surface of the second interfacial layer 40, a second pattern layer 80 that is located on another surface of the substrate layer 10 as well as a surface layer 70 that is located on the surface of the third interfacial layer 60.

It is clear from the three methods as shown in the above-mentioned preferred exemplary embodiments of the present invention that the adhesive layer 50, the first pattern layer 30 and the substrate layer 10 may be firmly combined by means of the first interfacial layer 20 and the second interfacial layer 40. In addition, subsequent to a high temperature treatment and a high pressure treatment of the adhesive layer 50, a strong adsorption effect may be automatically generated when the adhesive layer 50 is attached to any smooth surface. Besides the above, the first pattern layer 30 and the second pattern layer 70 may be respectively formed from the first surface 11 and the second surface 12 of the substrate layer 10, so as to enable the two sides of the silicon-colored composite patch of the present invention to show a printed pattern that is used for ornamental purposes, and this can significantly increase the aesthetic effects of the silicon-color composite patch of the present invention.

Although the above preferred exemplary embodiments of the present invention have been described with reference to the preferred exemplary embodiments thereof, it may be apparent to those ordinarily skilled in the art that a variety of modifications and changes may be made without departing from the scope of the present invention which is intended to be defined by the appended claims.

What is claimed is:

1. A method for manufacturing a silicon color composite patch, comprising the steps of:
providing a substrate layer that is made up of a heat-resistant material, wherein the substrate layer comprises a first surface and a second surface;
coating a first interfacial agent on the first surface of the substrate layer, and forming a first interfacial layer by means of drying the first interfacial agent;
forming a first pattern layer on a surface of the first interfacial layer;
coating a second interfacial agent on a surface of the first pattern layer, and forming a second interfacial layer by means of drying the second interfacial agent; and
placing an adhesive material on a surface of the second interfacial layer, and forming an adhesive layer by means of subjecting the adhesive material to a high temperature and a high pressure treatment, wherein the adhesive material comprises a silicone gel, a hardening agent, a colored plastic and an adhesive agent.

2. The method for manufacturing a silicon color composite patch in accordance with claim 1, wherein a rough surface is formed by means of subjecting at least a surface of the substrate layer to a surface roughening treatment, prior to the step of coating of the first interfacial agent.

3. The method for manufacturing a silicon color composite patch in accordance with claim 1, wherein subsequent to the step of forming of the adhesive layer, a further surface treatment is carried out, to enable the surface of the adhesive layer to be a smooth surface.

4. The method for manufacturing a silicon color composite patch in accordance with claim 1, wherein the first pattern layer is formed on the first interfacial layer by means of one of a method of spraying and a method of screen printing.

5. The method for manufacturing a silicon color composite patch in accordance with claim 1, wherein the heat-resistant material is selected from a group of a PET plate, an aluminum plate and a galvanized iron plate.

6. The method for manufacturing a silicon color composite patch in accordance with claim 1, wherein the heat-resistant material comprises a fiberglass cloth and an epoxy resin.

7. The method for manufacturing a silicon color composite patch in accordance with claim 1, wherein the heat-resistant material further comprises a graphite.

8. The method for manufacturing a silicon color composite patch in accordance with claim 1, wherein the method for manufacturing further comprises the steps of coating a third interfacial agent on the second surface of the substrate layer, and forming a third interfacial layer by means of drying a third interfacial agent; and forming a surface layer on a surface of a third interfacial layer.

9. The method for manufacturing a silicon color composite patch in accordance with claim 1, wherein the surface layer is selected from a group of a double-sided tape, a fiberglass plastic and a non-slip material.

10. The method for manufacturing a silicon color composite patch in accordance with claim 1, wherein the method for manufacturing further comprises the step of placing a second pattern layer on the second surface of the substrate layer.

11. The method for manufacturing a silicon color composite patch in accordance with claim 1, wherein the method of manufacturing further comprises the steps of coating the third interfacial agent on the surface of the second pattern layer, and forming the third interfacial layer by means of drying the third interfacial agent; and forming the surface layer on the surface of the third interfacial layer.

12. The method for manufacturing a silicon color composite patch in accordance with claim 1, wherein the surface layer is selected from a group of the double-sided tape, the fiberglass plastic and non-slip material.
